(19) United States
(12) Patent Application Publication
(10) Pub. No.: US 2005/0114164 A1
(43) Pub. Date: May 26, 2005

(54) Method of and system for coordinating events between applications of a customer relationship management system

(76) Inventor: Stephen J. Lyons, Pelham, NH (US)

Correspondence Address: MCDERMOTT WILL & EMERY LLP;ATTN: INTELLECTUAL PROPERTY DEPTARTMENT DOCKETING, 28 STATE STREET, BOSTON, MA, 02109, US

(21) Appl. No.: 10/887,235

(22) Filed: Jul. 8, 2004

Related U.S. Application Data
(60) Provisional application No. 60/525,255, filed on Nov. 26, 2003.

(51) Int. Cl. G06F 17/60

(52) U.S. Cl. 705/1

(57) ABSTRACT

A method of coordinating information includes receiving an event that includes information pertaining to a user, applying at least one rule associated with the event that includes an action and at least one condition by comparing the received information to the at least one condition to determine if the received information matches the at least one condition, and upon determining that the received information matches the at least one condition, initiating the action associated with the at least one rule.

The application claims priority to the provision application 60/525,255 entitled “Method of and System for Coordinating Events Between Applications of a Customer Relationship Management System” that was filed on Nov. 26, 2003 which is herein incorporated by reference.

### FIELD OF THE INVENTION

The present invention relates generally to a method of and system for coordinating events between business applications and, more particularly, to a method of and system for applying event inputs to a processing system comprising rules prescribing predefined actions to be carried out in response to predetermined inputs, and carrying out one or more of the predefined actions if conditions of any of the rules are met by the event inputs.

### BACKGROUND

Information has become a very valuable commodity to businesses, particularly in the service industries where information about the business activities of a company's customers can affect how the company operates. Information about customer spending habits can enable a business to cater to the needs of the customers, while increasing the volume of business overall.

However, while businesses are able to collect vast amounts of information about their customers, depending on the information, there is not always a way to maximize the usefulness of the information that is collected. The information collected by businesses is only valuable if the businesses are able to apply the information in such a way that the information generates more business. An example of a present method of collecting customer information from customers of a business is depicted in FIG. 1. In this example, a customer telephones a business' call center to change the address on her account, step 10. An operator at the call center receives the information, step 12, and enters the new address into the business' computer system, where it is stored in the system's data warehouse, step 14. If the business' sales force has direct, automatic access to this data warehouse, it can obtain the new information, step 16. However, if it does not, or if there are any other divisions or departments of the business that do not have automatic access to this data warehouse, the new information remains in the data warehouse and is not used to its full business potential.

### SUMMARY OF THE INVENTION

The present invention includes a system for enabling a business, an information technology (IT) manager, or other person who has control over the system (generally referred to as a system administrator) to describe how key business events detected on a given business application are distributed to other applications that can take advantage of this information. The system enables the administrator to generate one or more predetermined sets of rules that are applied to incoming information to determine whether the information will be passed to other applications of the business and which applications will receive the information in accordance with the sets of rules. By sharing the incoming information, the business can enable each of its relevant applications to immediately share and use the information, improve operations, increase revenues, and decrease costs.

According to one aspect of the invention, a method of coordinating information includes:
A. receiving an event that includes information pertaining to a user;
B. applying at least one rule associated with the event that includes an action and at least one condition by comparing the received information to the at least one condition to determine if the received information matches the at least one condition; and
C. upon determining that the received information matches the at least one condition, initiating the action associated with the at least one rule.

One or more of the following features may also be included. The method may determine if additional user-associated information, separate from the received information, is needed to apply the at least one rule. A storage location of the additional user-associated information may be determined and the additional user-associated information may be retrieved from the storage location. To determine whether to initiate the action, the at least one rule may be applied using the additional user-associated information. The event may be received from an adapter in communication with an application. The action may include sending a portion of the received information to an adapter in communication with an application. The received information may identify a user account. The adapter may be in communication with an application executed at a telephone call center. The adapter may be in communication with an application executed at a sales force automation system. The event may include a money transfer event.

In another implementation, a computer program product residing on a computer readable medium having a plurality of instructions stored thereon which, when executed by a processor, cause that processor to receive an event that includes information pertaining to a user, apply at least one rule associated with the event that includes an action and a least one condition by comparing the received information to the at least one condition to determine if the received information matches the at least one condition, and upon determining that the received information matches the at least one condition, initiate the action associated with the at least one rule.

One or more of the following features may also be included. The computer program product may include instructions for determining if additional user-associated information, separate from the received information, is needed to apply the at least one rule. A storage location of the additional user-associated information may be determined and the additional user-associated information may be retrieved from the storage location. The at least one rule may be applied using the additional user-associated information to determine if to initiate the action. The event may be received from an adapter in communication with an application. The action may include sending a portion of the received information to an adapter in communication with an application. The received information may identify a user account. The adapter may be in communication with an application executed at a telephone call center. The adapter may be in communication with an application executed at a sales force automation system. The event may include a money transfer event.

In another implementation, a system for coordinating information in a customer relationship management system includes an event receiver for receiving an event that includes information pertaining to a user, a rules processing engine for applying at least one rule associated with the event that includes an action and at least one condition by comparing the received information to the at least one condition to determine if the received information matches the at least one condition, and an action dispatcher for initiating the action associated with the at least one rule upon determining that the received information matches the at least one condition.

One or more of the following features may also be included. The rules processing engine may determine if additional user-associated information, separate from the received information, is needed to apply the at least one rule. The system may include a data fetcher for determining a storage location of the additional user-associated information and retrieving the additional user-associated information from the storage location. The rules processing engine may apply the at least one rule using the additional user-associated information. The event may be received from an adapter in communication with an application. The action may include sending a portion of the received information to an adapter in communication with an application. The received information may identify a user account. The adapter may be in communication with an application executed at a telephone call center. The adapter may be in communication with an application executed at a sales force automation system. The event may include a money transfer event.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a schematic process flow diagram illustrating a prior art method of distributing customer information;

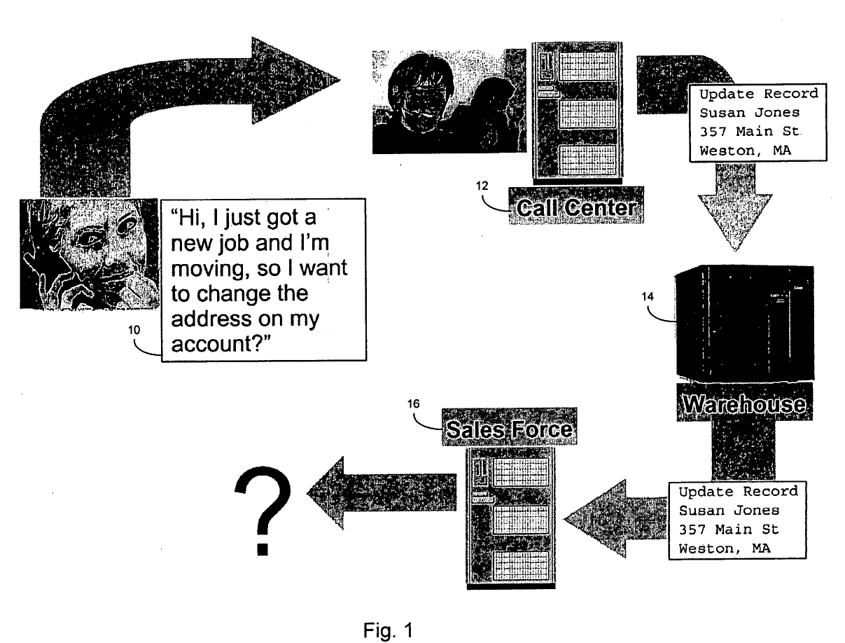

FIG. 2 is a diagrammatic view of a system for coordinating events between applications;

FIG. 3 is a flow diagram of the steps of the method for coordinating events between applications;

FIG. 4 is a screen print out of a user interface associated with the rules processing system of the present invention which enables a user to generate rules;

FIG. 5 is a schematic diagram showing an exemplary rule set;

FIG. 6 is a functional block diagram of the rules processing system;

FIG. 7 is a schematic diagram which shows the interaction between the components of the system for coordinating events; and

FIG. 8 is a schematic diagram which shows a flow of information between the components of the system for coordinating events.

### DETAILED DESCRIPTION OF THE PREFERRED EMBODIMENTS

The present invention enables a user of a business' computer system to generate rules describing how key business events and data associated with these events are propagated to other applications that can take advantage of the knowledge of these events and associated data. When the information that enters the system as a result of the event satisfies a condition of one of the rules, an action prescribed by the rule is carried out. Examples of such actions are: notifying a sales force of a new address of the customer, notifying a banking division of the business that a customer has withdrawn a particular sum of money and notifying a customer satisfaction division of a complaint of the customer.

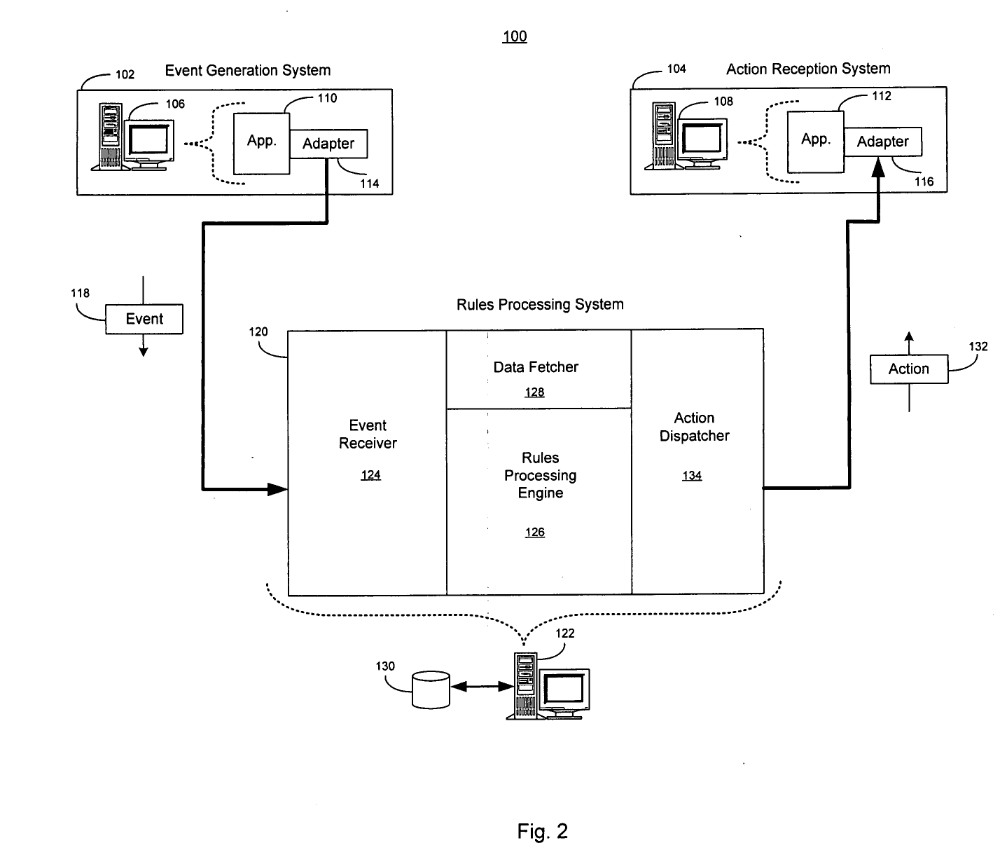

FIG. 2 shows a diagram of a system 100 for coordinating one or more predefined events between an event generation system 102 and an action reception system 104. In this particular arrangement both the event generation system 102 and the action reception system 104 respectively include computer systems 106, 108 (e.g., desktop systems, servers, etc.) that respectively execute application programs 110, 112 that are capable of generating events and carrying out certain actions as defined by one or more predetermined rules in accordance with a preferred embodiment of the present invention. A user predefines one or more rules, each conditioned on one or more events occurring depending on the event generation system 102 and the action reception system 104 (e.g., the particular type of applications being executed). An adapter 114 included in system 100 is configured to detect any of the predefined events from event generation system 102. In this example, the adapter 114 is in local communication with the executed application 110, however, in some arrangements communication is indirect and the adapter 114 is executed on a computer system remote from the even generation system. Also, while the event generation system 102 in this example includes the computer system 106 to initiate an event from a customer or entity, in other arrangements another mechanism such as a call placed through a telephone can trigger an event.

The adapter 114 preferably gathers all contextual data (e.g., customer name, etc.) relevant to the detected event, which resides locally in the event generation system 102. It then transmits an event packet 118 to a rules processing system 120 that is executed by a computer system 122. In this arrangement the event packet 118 is received by event reception logic of an event receiver 124, using an appropriate service or protocol. Preferably, the event packet 118 is transmitted over a Java Message Service (JMS), or alternatively over a simple object access protocol (SOAP) or Simple Mail Transport Protocol (SMTP), or by other protocols and services evident to those skilled in the art. If an event defined in the received event packet 118 matches that of one or more of the predefined events in one or more rules, those rules are evaluated by rule processing logic of a rules processing engine 126 that is included in the rules processing system 120. As a rule is evaluated, if the rule contains a condition and the condition needs contextual information not passed from the event generation system 102 (e.g., originating application 110), data fetching logic of a data fetcher 128 is invoked to retrieve the missing data from one or more external data sources such as a storage device 130 (e.g., hard drive, CD-ROM, etc.) that is in communication with the computer system 122. Alternatively, in some arrangements the missing data may be retrieved from another computer system (e.g., server, etc.) in communication with the rules processing system 120.

If all the conditions of a rule are satisfied, then one or more actions defined by that rule are invoked and sent to the action reception system 104 for execution. In this example a packet 132 that includes a particular action is sent to the application 112 executed at the action reception system 104, however, the action packet can be sent to additional applications or multiple action packets may be generated and sent from the rules processing system to appropriate applications. In this arrangement, the action packet 132 is sent through an appropriate adapter 116 and if necessary, via action dispatching logic of an action dispatcher 134. The action and associated contextual data are forwarded to the action reception system 104 using any type of service or protocol, and preferably over JMS or alternatively over SOAP or SMTP. Although not required, the event receiver 124, the rules processing engine 126, the data fetcher 128, and the action dispatcher 134 included in the rules processing system 108 may all reside on a server upon which a website is hosted, or on a computer system suitably connected to receive event information from the event generation system 102 through the adapter 114. Also, in this arrangement the data representing the event detected and data representing the action to be taken are respectively transferred between the systems 102, 104 and the rules processing system 120 in packets 118, 132. However, in other arrangements the data is transferred in a series of packets or by implementing other data passing techniques (e.g., modulated signals, etc.).

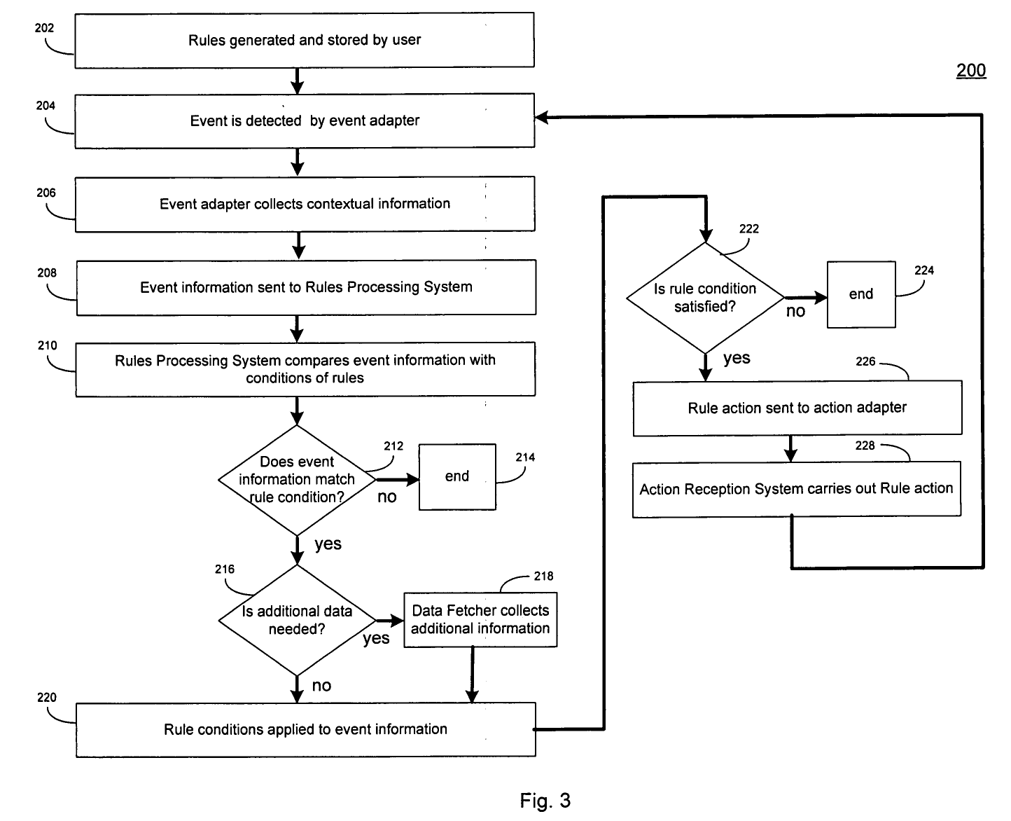

FIG. 3 is a flow diagram 200 generally showing the steps of the preferred method of coordinating events between applications of a customer relationship management system according to the invention. Each of the steps will be described in detail below. In step 202, the administrator or other manager of the business generates predefined rules, which are then stored so as to define the rules processing logic of the rules processing system 120.

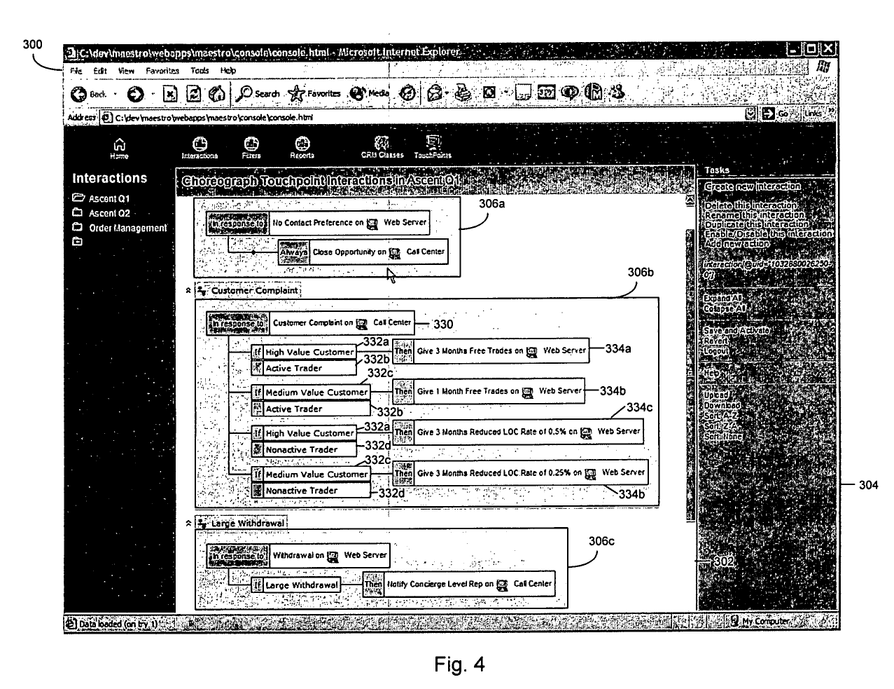

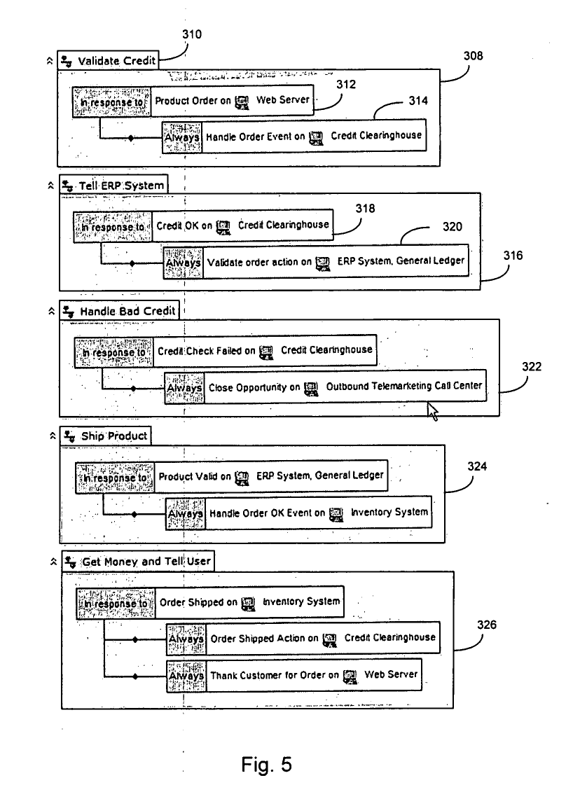

The rules are preferably generated with the use of a graphical user interface, such as the one shown as a screen shot in FIG. 4. As shown in FIG. 4, the preferred graphical user interface 300 generally includes a main rules window 302 and a tasks bar 304 that includes the commands for enabling an administrator to generate rules or, as more specifically indicated in the figure, interactions. As an example, graphical representations of several rules, 306a, 306b, 306c, are shown in the main rules window 302. Additional graphical representations of exemplary rules are shown as a rule set in FIG. 5.

As shown with reference to example rule 308 in FIG. 5, each rule is comprised of a title 310 (e.g., “Validate Credit”), an event 312 (e.g., “In response to: Product order on Web Server”), and an action 314 (e.g., “Always: Handle Order Event on Credit Clearinghouse”).

Using the rule 308 of FIG. 5, as an example and referring again to FIG. 3, when a customer provides an event as an input to the system 100, such as ordering a product offered for sale by the business, for example, through a website associated with the business, the event is detected, step 204, and contextual information (e.g., customer name) is collected by the adapter 114, step 206. Once the contextual information is collected, the information about the event is transmitted in the event packet 118 through the adapter 114 to event reception logic of the event receiver 124, as illustrated by step 208 of FIG. 3.

When the event packet 118 is received by the event receiver 124, the event receiver sends the event information included in the event packet 118 to the rules processing engine 126. The rules processing engine 126 receives the event information and compares it to the rules stored in the rules processing system 120, step 210. In this example, the event information is indicative that a product order is being place through the business' website by the rules processing engine 126 determining if the event information and the condition 312 of rule 308 match, step 212. In the event that event information received by the rules processing system 120 does not match conditions in any of the stored rules, the process is ended, step 214. Since the event information does match the condition 312 of rule 206, the affirmative path from step 212 is followed.

In step 216, the process determines whether more information is needed to apply the rule to the event information. This would be the case if the action associated with the rule is different depending on dynamic information which is not included with the event information, but which is stored elsewhere within the business' computer system. As will be described in below, if additional information is determined to be needed in step 216, the data fetcher 128 is invoked to retrieve the needed data, step 218.

Since the example rule set of FIG. 5 needs no additional information, the rule condition is applied to the event information by the rules processing system, step 220. In this example, the rule condition is satisfied, step 222, because the event information does indeed indicate that a product order is taking place on the web server. Accordingly, the action portion 314 of the rule 308 is carried out by transmitting action instructions from the action dispatcher 134 to the action reception system 104 for reception by executed application 112 via the adapter 116, step 226. In one particular example, the action reception system 104 is a credit clearinghouse as indicated in the rule action 314. The action reception system 104 then carries out the action, step 228, which, in this example, is to handle the incoming order. The process 200 then returns to step 204, and in this particular arrangement, the credit clearinghouse, which was the action reception system 104 during the application of rule 206, now becomes an event-initiating system, such as the event generation system 102, since the result of the credit check carried out by the credit clearing house triggers an event and event information transmitted into the rules processing engine 120, step 208. The process 200 then repeats steps 210 to 228 for the newly received event information. During the application of rule 316, the event information, which is an approval or denial of credit, is applied to the condition 318 of the rule 316. If the condition is satisfied, the action 320 is carried out by an Enterprise Resource Planning (ERP) system associated with the business. The remaining rules 322, 324, 326 of the rule set are similarly processed according to the steps shown in FIG. 3.

As set forth above, in some instances, the rules applied to the event information will require more information than included in the event information. Such a rule is shown at 306b in FIG. 4. In rule 306b, the event 330 is the reception of a customer complaint event via a telephone call center associated with the business. When the rules processing engine 126 determines, at step 212 (shown in FIG. 3), that an incoming event to the event receiver 124 (in this example, a call center) is a customer complaint, it then applies the conditions 332a-332d to the event information. Each of the conditions require that the rules processing system 120 know the status of a particular customer, i.e. the “value” of the customer and the trading activity of the customer. However, this information is not included in the event packet 118 is transmitted to the rules processing system 120. Accordingly, in step 216 of FIG. 3, when it is determined that additional information is needed, the data fetcher 128 is invoked to retrieve the required information, step 218. In this instance, the rule is generated to include instructions to the data fetcher 128 regarding the location of the required information. Since this information may be stored in data warehouses which are not part of the system 100, the rules include classes that pertain to the type of data that is needed to carry out the application of the rule condition to the information. In this example, because information about the customer is needed, the rule condition includes instructions to the data fetcher 128 that the needed information should be accessed through the customer class. Other classes through which information may be obtained include a transaction type class, a household type class, a product sale type class, an account type class or any other definition within which information can be classified for facilitating the retrieval of the information by the data fetcher 128. This enables the data fetcher 128 to determine the location of the necessary information. This rule also includes a filter element which sets the parameters which are necessary for determining which of the actions 334a-334d are to be carried out. In this particular example, rule 306b requires that the rule processing engine 126 be able to determine if the customer is a “high value” (condition 332a) or “medium value” (condition 332c) customer and if the customer is an active trader (condition 332b) or a nonactive trader (condition 332d). Accordingly, the data fetcher 128 is instructed to obtain the value of the customer, as defined by the business, and this value is applied to a predefined filter which determines whether the customer's value is “high” or “medium.” Likewise, the trading activity of the customer is obtained by the data fetcher 128 and applied to a predefined filter which places the customer into the “active” or “nonactive” trader category. Based on the data obtained by the data fetcher 138 and the filters applied to the data, data representing one of the resulting actions 334a-334d is transmitted in the action packet 132 from the action dispatcher 134 to the action reception system 104. The adapter 116 passes appropriate data to the application 112 (e.g., a web browser) for carrying out the action (e.g., presenting information to a user).

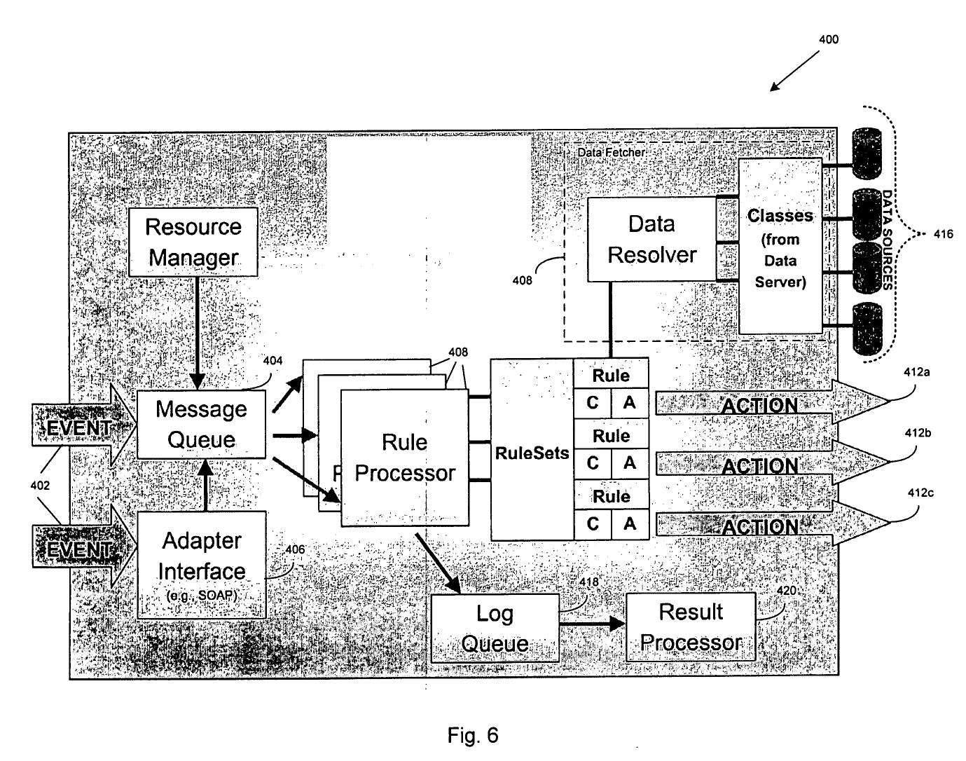

The operation of the rules processing system 120 is described with reference to FIG. 6, which presents a functional block diagram 400. As mentioned, events 402 transmitted to the rules processing system 120 are received by the event receiver 124. The events 402 can be transmitted directly into a message queue 404 and temporarily stored prior to processing or the events can be transmitted to the message queue 404 through an adapter interface 406, which is preferably uses a simple object access protocol (SOAP), a Simple Mail Transfer Protocol (SMTP), or other type of protocol. Alternatively, a third party adapter interface may be used to receive events. Once received, in this arrangement the events are processed by one or more rule processing engines 408 to determine if the event matches one or more rules from a rule set 410. Each rule in the rule set 410 includes a condition “C” and a corresponding action “A”. For each condition of each rule that is met, the respective action 412a-412c is transmitted, for example, to the action reception system 104, which as mentioned may include one or more applications such as business applications where the action is carried out. If the condition of an applicable rule requires additional information which is not included in the event information, a data fetcher 414, similar to the data fetcher 128 shown in FIG. 2, is summoned to obtain the needed information. The data fetcher 414 obtains the information from data sources 416 (e.g., storage device 130 shown in FIG. 2) that store particular classes that categorize the information. The rules processing system 120 may also include a log queue 418 for monitoring the events and resulting actions processed by the rule processing engines 408 and a results processor 420 for generating reports of the activity of the rule processing engines 408.

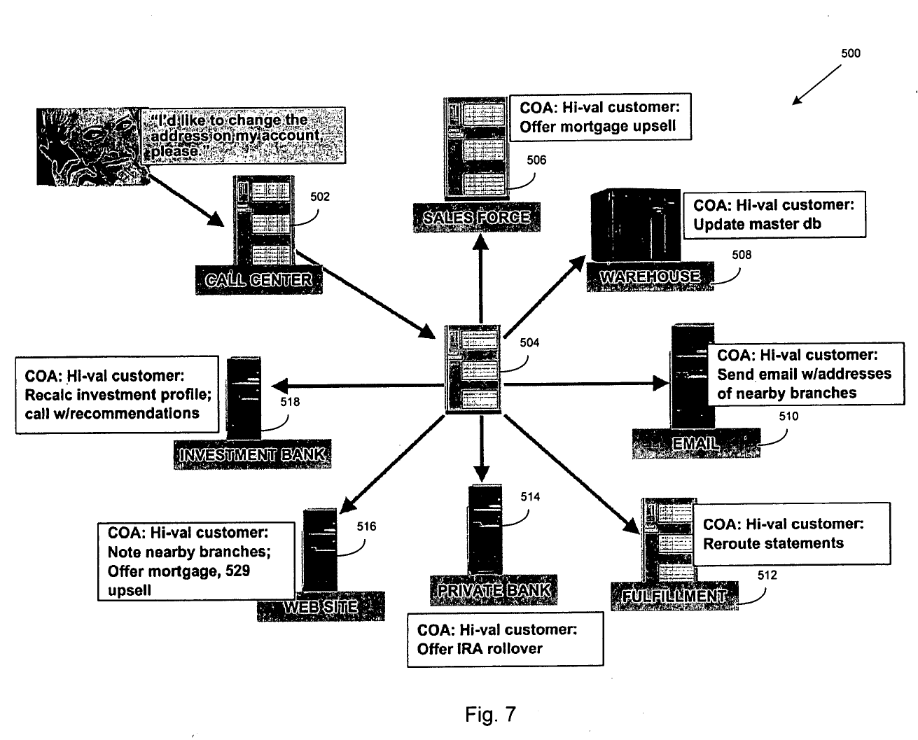

FIG. 7 is a schematic diagram of a system 500 which shows how event generation systems and action reception systems are interrelated and interconnected. As shown in FIG. 7, a customer contacts the customer call center 502 of a banking institution via a telephone to change the address on her account. In this case, the call center 502 provides the functionality of the event generation system 102 (shown in FIG. 2). The event information received by the call center 502 is transmitted to a server 504 in which the rules processing system 120 (shown in FIG. 2) is executed. Based on the rules that are determined by the rules processing system 120 to be applicable to the event information, a number of actions are possible. For example, the customer's address change information could be forwarded to a sales force division 506 of the institution for the purpose of notifying the sales force that a mortgage upsell may be offered. The determination to forward the information to the sales force division 506 is based on the condition that the customer is a “high value” customer. As described above, in order to make this determination, the rules processing system 120 invokes the data fetcher 128 to obtain the information required to determine the value of the customer. The customer information could also be forwarded to a data warehouse 508 for the purpose of updating the master database. An email system 510 receives the address information for the purpose of notifying the customer of the locations of nearby branches of the institution. The fulfillment division 512 of the institution receives the address information so that it can automatically reroute the customer's statements to the new address. A private bank system 514 which is affiliated with the institution receives the customer's information for the purpose of enabling the bank to offer banking products to the customer. A web site system 516 associated with the institution may receive the customer's information for the purpose of enabling the institution to contact the customer via the Internet to offer further services and an investment bank 518 associated with the institution may also receive the customer's information for similar purposes. In this example, each of systems 506-518 are acting as action reception systems similar to the action reception system 118 (shown in FIG. 2). However, after each system receives the customer's information, if further applicable rules dictate that information resulting from processing performed by one or more of the systems 506-518 be transferred back to the rules processing system 120, the system that is transmitting the information then becomes an event generation system, since it is then transmitting event information to the rules processing system 120. This is the case in the example shown in FIG. 5, where in rule 308, the credit clearinghouse is acting as an action reception system prior to its operation, and as an event generation system after it has processed the information to determine if the customer's credit is accepted or denied. The acceptance/denial information is an event which is then transmitted back to the rules processing system 120 before it is transmitted to the ERP system if the credit is accepted, rule 316, or to the outbound telemarketing call center if the credit is denied, rule 322. The systems called upon for processing in rules 324 and 326 operate in a similar manner.

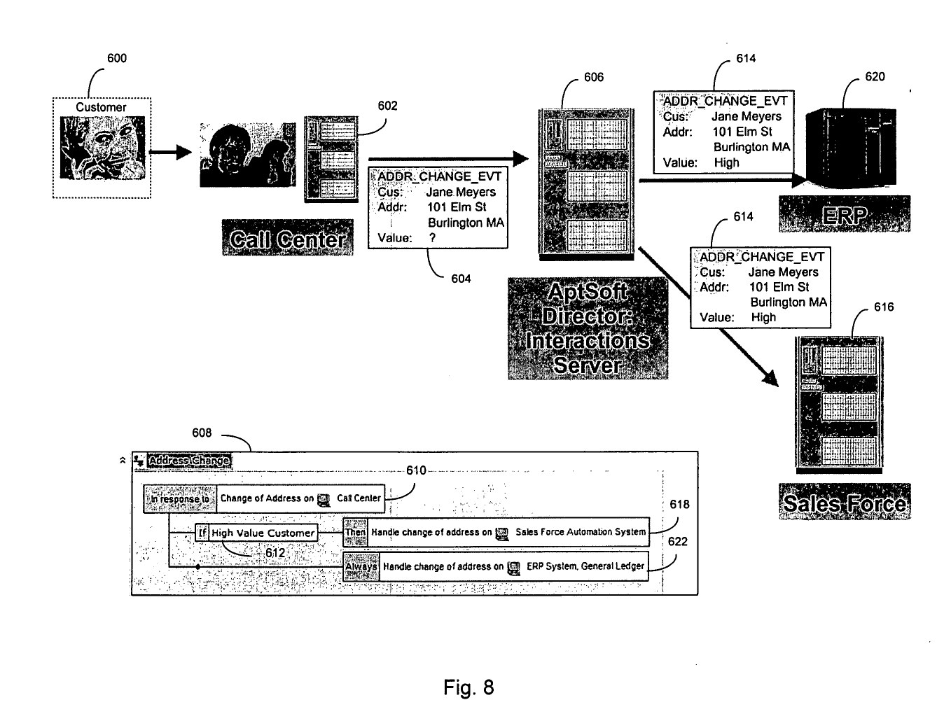

FIG. 8 is a schematic diagram which shows how data that represents an incoming event information is transmitted through the system 100. As shown at 600, the process begins when the customer telephones the call center 602 to request that the address on her account be changed. In this case, the call center 602 is operating as an event generation system such as the event generation system 102 (shown in FIG. 2). The pertinent information is input to the call center 602 and the event information, shown schematically at 604, is transmitted to a server 606 in which the rules processing system 120 (shown in FIG. 2) is executed. The rules processing system 120, following the flow diagram shown in FIG. 3, determines that the event is an address change and searches a data storage system (e.g., storage device 130), which can be internal or external to the rules processing system, to find any rules that would apply to address change events. The rule shown at 608 is found, which applies to address change event received through the call center, as indicated at 610. The rules processing system 120 examines the rule and determines that all of the necessary information required to apply condition 612 of the rule to the event information, specifically the customer value, is not included in the event information. Therefore, the rules processing system 120 invokes the data fetcher 128 (shown in FIG. 2) to obtain the needed information. When the information is obtained according to the process described above, the completed event information is then applied to the rule. In this example, the customer value fits the predefined “high value” category, thus satisfying condition 612 of the rule, and therefore, the completed event information, shown schematically at 614, is forwarded to the sales force system 616, as dictated by action 618 of the rule, and to ERP system 620, as dictated by action 622 of the rule. The respective actions 618, 622 are then carried out on each system.

It is noted that the present invention need not replace any portion of the business' existing computer system. It can supplement the system by directing incoming event information to already existing departments of the business system. Therefore, the system of the present invention can be implemented according to a timetable that is dictated by the administrator. It does not need to be implemented all at once. The administrator can choose to generate as many or as few rules as are deemed necessary for the particular business.

Accordingly, the present invention enables an administrator of a business to generate rules to which incoming information is applied. The rules include conditions which, if met, determine where within the business system the incoming information is to be sent for the purpose of performing an action based on the information. The system enables a business to use incoming information on a real-time basis for the purpose of increasing opportunities to create more business and for providing improved customer service. Since the incoming information is acted upon immediately, the business that receives the information is in a better position to use the information for its benefit and for the benefit of the customer.

The invention may be embodied in other specific forms without departing from the spirit or essential characteristics thereof. The present embodiments are therefore to be considered as illustrative and not restrictive, the scope of the invention being indicated by the appended claims rather than by the foregoing description, and all changes which come within the meaning and range of the equivalency of the claims are therefore intended to be embraced therein.

1. A method of coordinating information comprising:
receiving an event that includes information pertaining to a user;
applying at least one rule associated with the event that includes an action and at least one condition by comparing the received information to the at least one condition to determine if the received information matches the at least one condition; and
upon determining that the received information matches the at least one condition, initiating the action associated with the at least one rule.

2. The method of claim 1 further comprising:
determining if additional user-associated information, separate from the received information, is needed to apply the at least one rule.

3. The method of claim 2 further comprising:
determining a storage location of the additional user-associated information and retrieving the additional user-associated information from the storage location.

4. The method of claim 3 further comprising:
applying the at least one rule using the additional user-associated information to determine if to initiate the action.

5. The method of claim 1 wherein the event is received from an adapter in communication with an application.

6. The method of claim 1 wherein the action includes sending a portion of the received information to an adapter in communication with an application.

7. The method of claim 1 wherein the received information identifies a user account.

8. The method of claim 5 wherein the adapter is in communication with an application executed at a telephone call center.

9. The method of claim 6 wherein the adapter is in communication with an application executed at a sales force automation system.

10. The method of claim 1 wherein the event includes a money transfer event.

11. A computer program product residing on a computer readable medium having a plurality of instructions stored thereon which, when executed by a processor, cause that processor to:
receive an event that includes information pertaining to a user;
apply at least one rule associated with the event that includes an action and a least one condition by comparing the received information to the at least one condition to determine if the received information matches the at least one condition; and
upon determining that the received information matches the at least one condition, initiate the action associated with the at least one rule.

12. The computer program product of claim 11 further comprising instructions for:
determining if additional user-associated information, separate from the received information, is needed to apply the at least one rule.

13. The computer program product of claim 12 further comprising instructions for:
determining a storage location of the additional user-associated information and retrieving the additional user-associated information from the storage location.

14. The computer program product of claim 13 further comprising instructions for:
applying the at least one rule using the additional user-associated information to determine if to initiate the action.

15. The computer program product of claim 11 wherein the event is received from an adapter in communication with an application.

16. The computer program product of claim 11 wherein the action includes sending a portion of the received information to an adapter in communication with an application.

17. The computer program product of claim 11 wherein the received information identifies a user account.

18. The computer program product of claim 15 wherein the adapter is in communication with an application executed at a telephone call center.

19. The computer program product of claim 16 wherein the adapter is in communication with an application executed at a sales force automation system.

20. The computer program product of claim 11 wherein the event includes a money transfer event.

21. A system for coordinating information in a customer relationship management system comprising:
an event receiver for receiving an event that includes information pertaining to a user;
a rules processing engine for applying at least one rule associated with the event that includes an action and at least one condition by comparing the received information to the at least one condition to determine if the received information matches the at least one condition; and
an action dispatcher for initiating the action associated with the at least one rule upon determining that the received information matches the at least one condition.

22. The system of claim 21 wherein the rules processing engine determines if additional user-associated information, separate from the received information, is needed to apply the at least one rule.

23. The system of claim 22 further comprising:
a data fetcher for determining a storage location of the additional user-associated information and retrieving the additional user-associated information from the storage location.

24. The system of claim 23 wherein the rules processing engine applies the at least one rule using the additional user-associated information.

25. The system of claim 21 wherein the event is received from an adapter in communication with an application.

26. The system of claim 21 wherein the action includes sending a portion of the received information to an adapter in communication with an application.

27. The system of claim 21 wherein the received information identifies a user account.

28. The system of claim 25 wherein the adapter is in communication with an application executed at a telephone call center.

29. The system of claim 26 wherein the adapter is in communication with an application executed at a sales force automation system.

30. The system of claim 21 wherein the event includes a money transfer event.
